(19) United States
(12) Patent Application Publication
(10) Pub. No.: US 2018/0357465 A1
(43) Pub. Date: Dec. 13, 2018

(54) SYSTEM AND METHOD FOR AUTOMATIC LOGGING OF EVENTS IN INDUSTRIAL PROCESS CONTROL AND AUTOMATION SYSTEM USING CHANGE POINT ANALYSIS

(71) Applicant: Honeywell International Inc., Morris Plains, NJ (US)

(72) Inventors: Nadesh Kumar Jegannathan, Hosur (IN); Suresh Daniel, Bengaluru (IN)

(21) Appl. No.: 15/616,019

(22) Filed: Jun. 7, 2017

(51) Int. Cl. G06K 9/00; G06F 17/18; G06F 11/07

(52) U.S. Cl. CPC G06K 9/0053; G06F 17/18; G06F 11/0769; G06F 11/0709; G06F 11/0736

(57) ABSTRACT

A method includes obtaining history trend data of a process variable. The method also includes determining one or more change points in a mean value of the process variable for a predetermined time interval in the history trend data using change point analysis. The method further includes detecting one or more significant change points that occur in the mean value of the process variable during the predetermined time interval. In addition, the method includes, for each detected significant change point, providing a notification to a user of the significant change point, receiving information from the user about a cause of the significant change point and generating an event in a log. The event is based on the significant change point and the information received from the user about the significant change point.

### TECHNICAL FIELD

This disclosure relates generally to industrial process control and automation systems. More specifically, this disclosure relates to a system and method for automatic logging of events in an industrial process control and automation system using change point analysis.

### BACKGROUND

Industrial process control and automation systems are often used to automate large and complex industrial processes. These types of systems routinely include sensors, actuators, and controllers. Some of the controllers typically receive measurements from the sensors and generate control signals for the actuators. Other controllers often perform higher-level functions, such as planning, scheduling, and optimization operations.

A distributed control system (DCS) is often implemented in conjunction with or as part of an industrial process control and automation system. A DCS often uses one or more model predictive controllers (MPCs) in industrial processes to manage complex systems to operate at limits that are economically beneficial. Events associated with the DCS are typically entered automatically into an event log. However, some manual events, such as manual activities performed by a field operator, may not be logged automatically.

### SUMMARY

This disclosure provides a system and method for automatic logging of events in an industrial process control and automation system using change point analysis.

In a first embodiment, a method includes obtaining history trend data of a process variable. The method also includes determining one or more change points in a mean value of the process variable for a predetermined time interval in the history trend data using change point analysis. The method further includes detecting one or more significant change points that occur in the mean value of the process variable during the predetermined time interval. In addition, the method includes, for each detected significant change point, providing a notification to a user of the significant change point, receiving information from the user about a cause of the significant change point, and generating an event in a log. The event is based on the significant change point and the information received from the user about the significant change point.

In a second embodiment, an apparatus includes at least one processing device configured to obtain history trend data of a process variable. The at least one processing device is also configured to determine one or more change points in a mean value of the process variable for a predetermined time interval in the history trend data using change point analysis. The at least one processing device is further configured to detect one or more significant change points that occur in the mean value of the process variable during the predetermined time interval. In addition, the at least one processing device is configured, for each detected significant change point, to provide a notification to a user of the significant change point, receive information from the user about a cause of the significant change point, and generate an event in a log. The event is based on the significant change point and the information received from the user about the significant change point.

In a third embodiment, a non-transitory computer readable medium contains instructions that when executed cause at least one processing device to obtain history trend data of a process variable. The medium also contains instructions that when executed cause the at least one processing device to determine one or more change points in a mean value of the process variable for a predetermined time interval in the history trend data using change point analysis. The medium further contains instructions that when executed cause the at least one processing device to detect one or more significant change points that occur in the mean value of the process variable during the predetermined time interval. In addition, the medium contains instructions that when executed cause the at least one processing device, for each detected significant change point, to provide a notification to a user of the significant change point, receive information from the user about a cause of the significant change point, and generate an event in a log. The event is based on the significant change point and the information received from the user about the significant change point.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates a graph representing a history trend of an example process variable in a process control and automation system according to this disclosure;

FIG. 3 illustrates an example user interface supporting automatic logging of events in a process control and automation system according to this disclosure;

FIG. 4 illustrates an example list of notification messages in a process control and automation system according to this disclosure;

FIG. 5 illustrates an example method for automatic logging of events in a process control and automation system according to this disclosure; and

FIG. 6 illustrates an example device supporting automatic logging of events in a process control and automation system according to this disclosure.

### DETAILED DESCRIPTION

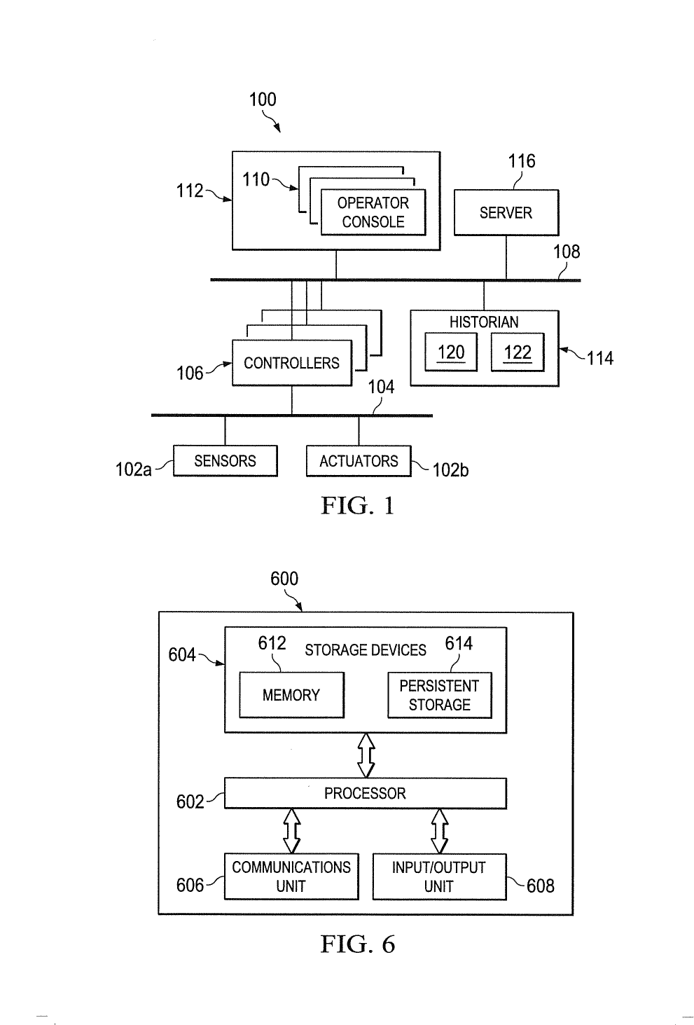

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 can be used to facilitate control over components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials in some manner.

In FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as pressure, temperature, or flow rate. Also, the actuators 1026 could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent at least one Ethernet network, electrical signal network (such as a HART network), pneumatic control signal network, or any other or additional type(s) of network(s).

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. A second set of controllers 106 could be used to optimize the control logic or other operations performed by the first set of controllers. A third set of controllers 106 could be used to perform additional functions. The controllers 106 can communicate via one or more networks 108 and associated switches, firewalls, and other components.

Each controller 106 includes any suitable structure for controlling one or more aspects of an industrial process. At least some of the controllers 106 could, for example, represent proportional-integral-derivative (PID) controllers or multivariable controllers, such as controllers implementing model predictive control or other advanced predictive control. As a particular example, each controller 106 could represent a computing device running a real-time operating system, a WINDOWS operating system, or other operating system.

Operator access to and interaction with the controllers 106 and other components of the system 100 can occur via various operator consoles 110. Each operator console 110 could be used to provide information to an operator and receive information from an operator. For example, each operator console 110 could provide information identifying a current state of an industrial process to the operator, such as values of various process variables and alarms associated with the industrial process. Each operator console 110 could also receive information affecting how the industrial process is controlled, such as by receiving setpoints or control modes for process variables controlled by the controllers 106 or other information that alters or affects how the controllers 106 control the industrial process. Each operator console 110 includes any suitable structure for displaying information to and interacting with an operator. For example, each operator console 110 could represent a computing device running a WINDOWS operating system or other operating system.

Multiple operator consoles 110 can be grouped together and used in one or more control rooms 112. Each control room 112 could include any number of operator consoles 110 in any suitable arrangement. In some embodiments, multiple control rooms 112 can be used to control an industrial plant, such as when each control room 112 contains operator consoles 110 used to manage a discrete part of the industrial plant.

The control and automation system 100 here also includes at least one historian 114 and one or more servers 116. The historian 114 represents a component that stores various information about the system 100. The historian 114 could, for instance, store information that is generated by the various controllers 106 during the control of one or more industrial processes. The historian 114 includes any suitable structure for storing and facilitating retrieval of information. Although shown as a single component here, the historian 114 could be located elsewhere in the system 100, or multiple historians could be distributed in different locations in the system 100. Each server 116 denotes a computing device that executes applications for users of the operator consoles 110 or other applications. The applications could be used to support various functions for the operator consoles 110, the controllers 106, or other components of the system 100. Each server 116 could represent a computing device running a WINDOWS operating system or other operating system.

Various events that occur in an industrial process control and automation system (such as the system 100) are logged into one or more alarm and event logs 120, which can be stored in the historian 114. Values of process variables over time can also be recorded and stored in one or more process variable history logs 122, which can be stored in the historian 114. However, certain events, such as field operator actions or other manual activities performed by human personnel, typically do not get logged in the alarm and event log 120 since these actions are performed directly by one or more humans instead of a computer control system. The outcomes of these actions (such as a reduction in a tank level when an operator opens a tank drain valve or an increase in fluid flow when an operator manually opens a pipe valve) are realized as changes in one or more process variable values and are typically recorded in the process variable history log 122. Unfortunately, the process variable history logs 122 are typically separate and distinct from the alarm and event logs 120, and there may be a need to capture manual events in the computer-generated alarm and event logs 120 in order to ensure that all operational activities are logged in one place. This may be needed, for instance, since the logs 120 are typically used as data sources for operational analysis.

As described in more detail below, embodiments of this disclosure apply change point analysis techniques to industrial process variable history trend data to identify unlogged events in the system 100. Among other things, this allows such events to be included in computer-generated alarm and event logs 120. For example, one or more of the components in FIG. 1 (such as the operator consoles 110, the historian 114, or the server 116) could be configured to use change point analysis to automatically analyze process variable history trends in the process variable history logs 122 to detect change points and then generate corresponding events in the alarm and event log 120 if no events currently exist. This represents a technical advantage over alarm systems and other systems that do not automatically log these events. Additional details regarding these techniques are provided below.

Although FIG. 1 illustrates one example of an industrial process control and automation system 100, various changes may be made to FIG. 1. For example, the system 100 could include any number of sensors, actuators, controllers, networks, operator stations, control rooms, historians, servers, and other components. Also, the makeup and arrangement of the system 100 in FIG. 1 is for illustration only. Components could be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment where change point analysis can be used to identify and log events that occur in an industrial process and control and automation system. This functionality can be used in any other suitable system.

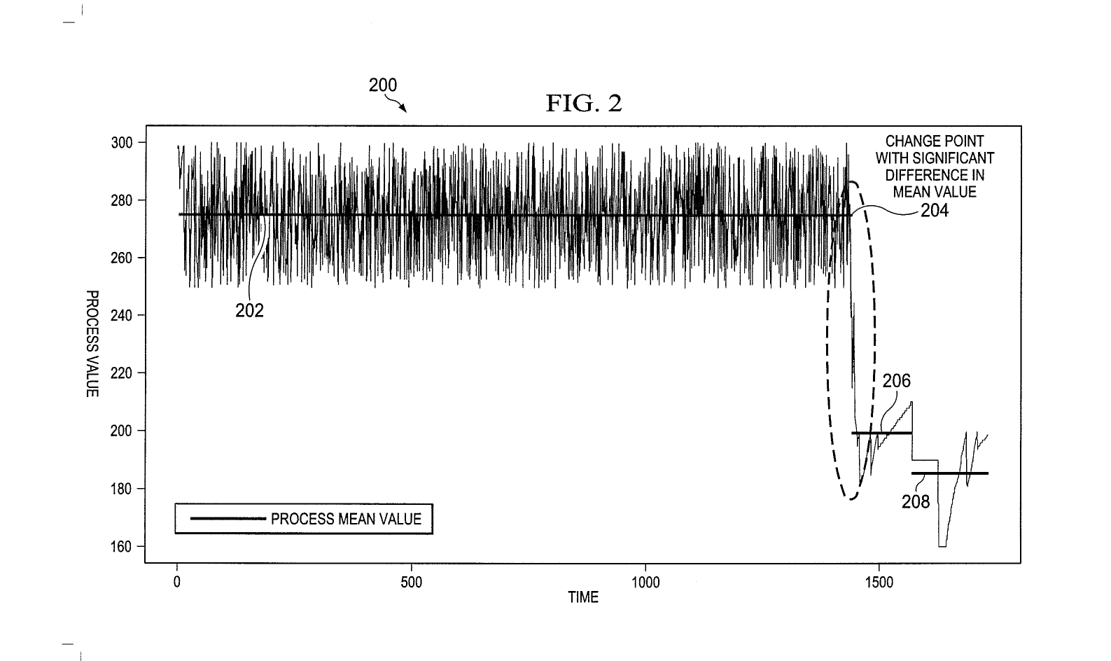

FIG. 2 illustrates a graph 200 representing a history trend of an example process variable in a process control and automation system according to this disclosure. For ease of explanation, the process variable shown in the graph 200 may be described as a process variable that changes during operation of one or more components in the system 100 of FIG. 1. However, the process variable could be related to any other suitable system.

The process variable shown in FIG. 2 can represent any of a wide variety of process variables that occur in an industrial process control and automation system. For example, the process variable can represent a flow into a condenser or a level of material in a tank. The history trend data for the process variable in FIG. 2 can be stored in a historian, such as the historian 114 of FIG. 1.

As shown in FIG. 2, the history trend plot of the process variable rises and falls but maintains a generally stable average for a prolonged period of time. That is, the value of the process variable stays primarily in a narrow range around a mean value 202. However, at a certain point 204 in time, the value of the process variable drops substantially and then starts to rise and fall unpredictably around other mean values 206 and 208. Because such rapid or unpredictable changes in value may be important in the overall operation of the process control and automation system, it can be helpful to determine if the reason for the rapid or unpredictable changes is due to a computer-controlled action or a manual action (such as a field operator manually opening a valve).

In a computer control system such as a DCS, actions are typically logged automatically as events. For example, an operation performed by a control system operator via a control system user interface would normally be logged automatically as an event since the action is performed via a computer. Similarly, an operation that is automatically performed by a process controller (such as one of the controllers 106 in

FIG. 1) would normally be logged automatically as an event since the action is performed a component of the system. Manual field operator actions typically are not logged automatically as events in a computerized event log since such manual events are not automatically detected by the control system. However, it can be important for such events to be logged, so change point analysis techniques can be used to identify such events. For example, the point 204 in time represents a change point that can be detected using change point analysis. Once a change point has been identified, the change point can be linked to an event that occurs in the overall system and then logged in one or more alarm and event logs, such as one of the alarm and event logs 120 of FIG. 1.

In some embodiments, the event detection and logging technique can include the following process. A history trend of a process variable is obtained, such as over a specified time interval. In some embodiments, this can include receiving process variable data from one or more process variable history logs 122. This can also include preparing the data for analysis, such as by filtering out erroneous data, identifying and labeling data segments in the data, and the like. The resulting history trend data can be represented by a graph, such as the graph 200.

Change point analysis can be used to automatically calculate the mean values of the process variable (such as indicated at 202, 206, and 208 in FIG. 2) for a specified time period t and identify the changes in the mean (e.g., change points such as point 204 in FIG. 2). The change point analysis can be configured to be performed by the system on demand by the user or automatically based on a pre-configured schedule, e.g., daily, weekly, monthly, at shift completion, etc. Here, the value t could be specified or set according to system requirements, based on user input, or in any other suitable manner. In some embodiments, t may be equal to 8 hours, although larger or smaller values are possible.

Based on the change points in the process variable over time, a program in the computer control system, for example, one or more of the components in FIG. 1 (such as the operator consoles 110, the historian 114, or the server 116), takes the change points and the change in the mean value at those points as input and determines if there is any significant change in the mean value at any of the input change points. This could include, for example, determining if the mean value changes by a specified threshold amount or percentage. Such a significant change represents a potential event to be logged. Different change point analysis techniques are known and can be used here, and techniques can be customized in accordance with this disclosure. For example, different thresholds can be used to represent significant changes, and different time intervals can be examined depending on the process variable. In some embodiments, the threshold amount may be equal to ±30%, although larger or smaller values are possible. Such values can be determined and set in advance, such as by a system administrator or manager.

If a change point with a significant change in the mean value is detected, a notification is sent to a system operator or other personnel. The notification can request that the personnel provide details for the change point, such as a cause for the change point or a reason why the change point occurred. The personnel can then provide details regarding the detected change point. For example, a system operator could provide such details according to a template in a user interface.

Based on the details provided by the personnel, an event can be automatically logged for the change point. For example, the event can be automatically added to an alarm and event log 120, which can be stored in the historian 114. Later, since the manual events are now part of the alarm and event log 120, those events can be analyzed along with other control system events, such as by a data mining or data reporting routine. Also or alternatively, information regarding an identified change point can be collected automatically, such as by performing text analysis of one or more shift logs for the time period in which the change point occurred.

Although FIG. 2 illustrates a graph 200 representing a history trend of an example process variable in a process control and automation system, various changes may be made to FIG. 2. For example, the graph 200 in FIG. 2 in meant to illustrate one example of a change point for a process variable, and any other suitable changes to process variables could be detected.

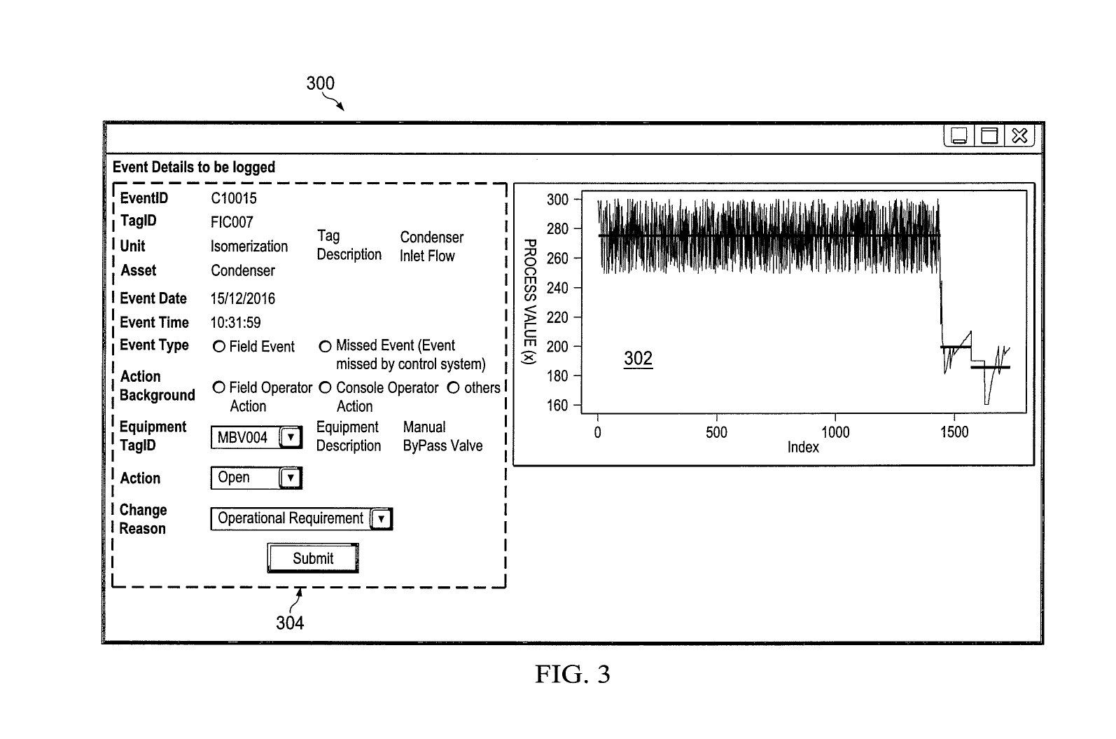

FIG. 3 illustrates an example user interface 300 supporting automatic logging of events in a process control and automation system according to this disclosure. The user interface 300 could, for example, be used for detecting and logging manual events that occur in the system 100 of FIG. 1. However, the user interface 300 could be used with any other suitable system. Also, the user interface 300 could be presented on the display screen of an operator console 110, although any other suitable devices could present the user interface 300.

The user interface 300 allows a user (such as a console operator or plant manager) to review one or more change points and provide details associated with the occurrence of each change point. As shown in FIG. 3, the user interface 300 includes a visual representation 302 of a graph and a user input section 304. In this example, the visual representation 302 represents the graph 200 of FIG. 2 and can show a process variable over time. The visual representation 302 can be included in the user interface 300 to provide additional information and context for a process variable change point to the user. For example, looking at the visual representation 302, the user can see what the trend of the process variable was before and after the change point.

The user input section 304 allows the user to provide information about the detected change point. The user input section 304 can be template-based and provides one or more user input controls and fields (such as radio buttons, check boxes, drop-down selection boxes, or text boxes). The input controls and fields allow the user to enter information associated with a change point of the process variable. For example, the user may enter information that a condenser inlet flow suddenly dropped because a field operator partially closed a valve at the condenser inlet. Because the user input section 304 may be template-based, different fields can be presented to the user to prompt for different types of information. The different fields could be based on a number of factors, such as the type of process variable associated with the detected change point.

Although FIG. 3 illustrates one example of a user interface 300 supporting automatic logging of events in a process control and automation system, various changes may be made to FIG. 3. For example, user interfaces can come in a variety of configurations, and FIG. 3 does not limit this disclosure to any particular configuration of user interface.

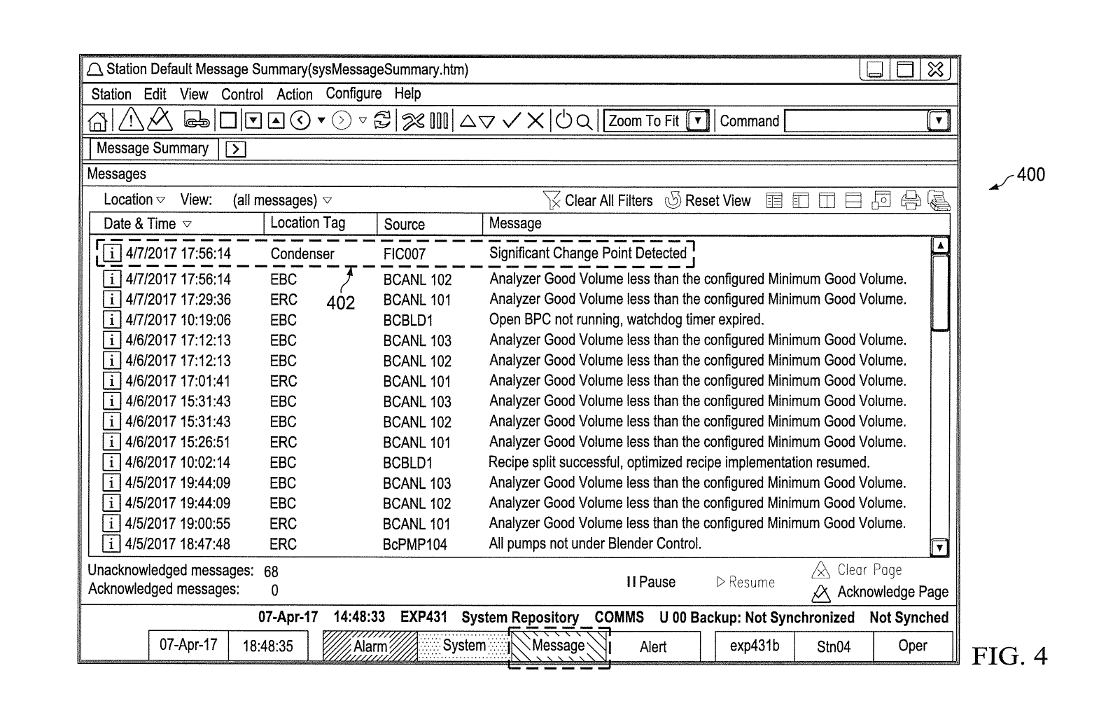

FIG. 4 illustrates an example list 400 of notification messages in a process control and automation system according to this disclosure. The list 400 could, for example, be used for prompting a user to provide information about detected events that occur in the system 100 of FIG. 1. However, the list 400 could be used with any other suitable system. Also, the list 400 could be presented on the display screen of an operator console 110, although any other suitable devices could present the list 400.

As shown in FIG. 4, the notification message list 400 is displayed in a user interface and presented to a user. The notification message list 400 includes various notification messages that can be automatically or manually generated in a process control and automation system, such as the system 100. A selected message 402 in

FIG. 4 represents a notification that a significant change point has been detected in a process variable. In some embodiments, an operator could actuate the message 402, such as by double-clicking the message 402, in order to open the user interface 300 so that the operator could review and provide information associated with the change point.

In some embodiments, the notification message list 400 includes recent messages displayed to an operator in real-time or near real-time, where the operator could receive and respond to the messages regularly. In other embodiments, the notification message list 400 represents historical notifications that can be analyzed at a later time, such as in a reporting routine. Whether the notification message list 400 is historical or real-time can depend upon the requirements of the user, system, or plant site.

Although FIG. 4 illustrates one example of a notification message list 400 in a process control and automation system, various changes may be made to FIG. 4. For example, message lists can come in a variety of configurations, and FIG. 4 does not limit this disclosure to any particular configuration.

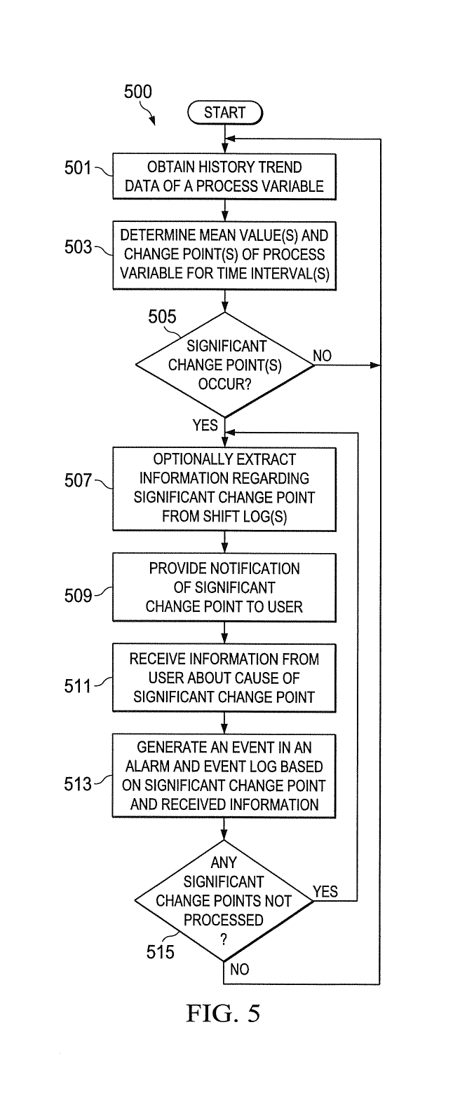

FIG. 5 illustrates an example method 500 for automatic logging of events in a process control and automation system according to this disclosure. For ease of explanation, the method 500 may be described as being performed using a computing device (such as the device 600 of FIG. 6 discussed below), which could be used to implement various devices in FIG. 1. However, the method 500 could be used with any suitable device or system.

At step 501, history trend data of a process variable is obtained. This may include, for example, obtaining history trend data of a process variable that is associated with one or more components in a process control and automation system. This may also include filtering out erroneous data and identifying and labeling data segments in the history trend data. The data can be obtained from any suitable source(s), such as from one or more process variable history logs 122 in a historian 114. At step 503, one or more mean values of the process variable and change points are determined for one or more time intervals in the history trend data using change point analysis. This may include, for example, determining the mean values of the process variable and the change points in the mean values for every t hours in the history trend data.

At step 505, a determination is made whether one or more significant change points occur in the mean value of the process variable. This may include, for example, using a computer application to detect significant change points, such as change points where the mean value changes by a specified amount or percentage within a given period of time. If no significant change point is detected, the method 500 returns to step 501 to continue analyzing the history trend data.

If a significant change point is detected, at step 507, information regarding the significant change point can be optionally extracted from one or more shift logs or other data sources for a time period in which the significant change point occurred. This may include, for example, performing text analysis (such as optical character recognition or natural language processing) to automatically extract the information regarding the significant change point. At step 509, a notification of the significant change point is provided to a user. This may include, for example, displaying the notification in a list of notification messages (such as the list 400) or displaying a graph of the significant change point at a user interface (such as the graph 200 in the user interface 300). At step 511, information about a cause of the significant change point is received from the user. This may include, for example, receiving information that is input by the user via a user interface (such as the user interface 300). At step 513, an event is generated in an alarm and event log, where the event is based on the significant change point and the information received from the user about the significant change point. This may include, for example, generating an event in an alarm and event log 120 that is stored in the historian 114 of the process control and automation system 100.

At step 515, it is determined if there are other significant change points that have not been processed yet. If so, the method 500 returns to step 507 to process the next significant change point. Otherwise, the method 500 can return to step 501 to analyze additional history trend data.

Although FIG. 5 illustrates one example of a method 500 for automatic logging of events in a process control and automation system, various changes may be made to FIG. 5. For example, while shown as a series of steps, various steps shown in FIG. 5 could overlap, occur in parallel, occur in a different order, or occur multiple times. Moreover, some steps could be combined or removed and additional steps could be added according to particular needs.

FIG. 6 illustrates an example device 600 supporting automatic logging of events in a process control and automation system according to this disclosure. The device 600 could, for example, represent the operator consoles 110, the historian 114, or the server 116 of FIG. 1. However, these components could be implemented using any other suitable device or system, and the device 600 could be used in any other suitable system.

As shown in FIG. 6, the device 600 includes at least one processor 602, at least one storage device 604, at least one communications unit 606, and at least one input/output (I/O) unit 608. Each processor 602 can execute instructions, such as those implementing the techniques described above that may be loaded into a memory 612. Each processor 602 denotes any suitable processing device, such as one or more microprocessors, microcontrollers, digital signal processors, application specific integrated circuits (ASICs), field programmable gate arrays (FPGAs), or discrete circuitry.

The memory 612 and a persistent storage 614 are examples of storage devices 604, which represent any structure(s) capable of storing and facilitating retrieval of information (such as data, program code, and/or other suitable information on a temporary or permanent basis). The memory 612 may represent a random access memory or any other suitable volatile or non-volatile storage device(s). The persistent storage 614 may contain one or more components or devices supporting longer-term storage of data, such as a read only memory, hard drive, Flash memory, or optical disc. The memory 612 or the persistent storage 614 may be configured to store information and data associated with automatic logging of events in a process control and automation system.

The communications unit 606 supports communications with other systems or devices. For example, the communications unit 606 could include a network interface card or a wireless transceiver facilitating communications over a wired or wireless network (such as the network 108). The communications unit 606 may support communications through any suitable physical or wireless communication link(s).

The I/O unit 608 allows for input and output of data. For example, the I/O unit 608 may provide a connection for user input through a keyboard, mouse, keypad, touchscreen, or other suitable input device. The I/O unit 608 may also send output to a display, printer, or other suitable output device.

Although FIG. 6 illustrates one example of a device 600 supporting automatic logging of events in a process control and automation system, various changes may be made to FIG. 6. For example, various components in FIG. 6 could be combined, further subdivided, or omitted and additional components could be added according to particular needs. Also, computing devices can come in a wide variety of configurations, and FIG. 6 does not limit this disclosure to any particular configuration of computing device.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining history trend data of a process variable;
determining one or more change points in a mean value of the process variable for a predetermined time interval in the history trend data using change point analysis;
detecting one or more significant change points that occur in the mean value of the process variable during the predetermined time interval; and
for each detected significant change point:
providing a notification to a user of the significant change point;
receiving information from the user about a cause of the significant change point; and
generating an event in a log, the event based on the significant change point and the information received from the user about the significant change point.

2. The method of claim 1, wherein the process variable is associated with one or more components in a process control and automation system.

3. The method of claim 1, wherein the one or more significant change points are detected using a computer program that compares a change in the mean value at each change point with a predetermined threshold value or percentage.

4. The method of claim 1, wherein:
providing the notification to the user of the significant change point comprises displaying a graph of the significant change point at a user interface; and
receiving the information from the user comprises receiving information that is input by the user at the user interface.

5. The method of claim 1, wherein providing the notification to the user of the significant change point comprises displaying the notification in a list of notification messages.

6. The method of claim 1, further comprising:
performing text analysis of one or more data sources for a time period in which each significant change point occurred to automatically extract information regarding the significant change point.

7. The method of claim 1, wherein obtaining the history trend data comprises filtering out erroneous data and identifying and labeling data segments in the history trend data. to 8. An apparatus comprising:
at least one processing device configured to:
obtain history trend data of a process variable;
determine one or more change points in a mean value of the process variable for a predetermined time interval in the history trend data using change point analysis;
detect one or more significant change points that occur in the mean value of the process variable during the predetermined time interval; and
for each detected significant change point:
provide a notification to a user of the significant change point;
receive information from the user about a cause of the significant change point; and
generate an event in a log, the event based on the significant change point and the information received from the user about the significant change point.

9. The apparatus of claim 8, wherein the process variable is associated with one or more components in a process control and automation system.

10. The apparatus of claim 8, wherein the at least one processing device is configured to detect the one or more significant change points by comparing a change in the mean value at each change point with a predetermined threshold value or percentage.

11. The apparatus of claim 8, wherein the at least one processing device is configured to:
provide the notification to the user of the significant change point by controlling a display to present a graph of the significant change point at a user interface; and
receive the information from the user by receiving information that is input by the user at the user interface.

12. The apparatus of claim 8, wherein the at least one processing device is configured to provide the notification to the user of the significant change point by controlling a display to present the notification in a list of notification messages.

13. The apparatus of claim 8, wherein the at least one processing device is further configured to perform text analysis of one or more data sources for a time period in which each significant change point occurred to automatically extract information regarding the significant change point.

14. The apparatus of claim 8, wherein the at least one processing device is configured to obtain the history trend data by filtering out erroneous data and identifying and labeling data segments in the history trend data.

15. A non-transitory computer readable medium containing instructions that when executed cause at least one processing device to:
obtain history trend data of a process variable;
determine one or more change points in a mean value of the process variable for a predetermined time interval in the history trend data using change point analysis;
detect one or more significant change points that occur in the mean value of the process variable during the predetermined time interval; and
for each detected significant change point:
provide a notification to a user of the significant change point;
receive information from the user about a cause of the significant change point; and
generate an event in a log, the event based on the significant change point and the information received from the user about the significant change point.

16. The non-transitory computer readable medium of claim 15, wherein the process variable is associated with one or more components in a process control and automation system.

17. The non-transitory computer readable medium of claim 15, wherein the instructions that when executed cause the at least one processing device to detect the one or more significant change points comprise:
instructions that when executed cause the at least one processing device to detect the one or more significant change points by comparing a change in the mean value at each change point with a predetermined threshold value or percentage.

18. The non-transitory computer readable medium of claim 15, wherein:
the instructions that when executed cause the at least one processing device to provide the notification to the user of the significant change point comprise:
instructions that when executed cause the at least one processing device to control a display to present a graph of the significant change point at a user interface; and
the instructions that when executed cause the at least one processing device to receive the information from the user comprise:
instructions that when executed cause the at least one processing device to control receive information that is input by the user at the user interface.

19. The non-transitory computer readable medium of claim 15, wherein the instructions that when executed cause the at least one processing device to provide the notification to the user of the significant change point comprise:
instructions that when executed cause the at least one processing device to control a display to present the notification in a list of notification messages.

20. The non-transitory computer readable medium of claim 15, further containing instructions that when executed cause the at least one processing device to:
perform text analysis of one or more data sources for a time period in which each significant change point occurred to automatically extract information regarding the significant change point.
